(19) United States
(12) Patent Application Publication
(10) Pub. No.: US 2016/0293318 A1
(43) Pub. Date: Oct. 6, 2016

(54) COIL COMPONENT

(71) Applicant: SAMSUNG ELECTRO-MECHANICS CO., LTD., Suwon-si (KR)

(72) Inventors: Ju Hwan Yang, Suwon-si (KR); Jong Bong Lim, Suwon-si (KR)

(21) Appl. No.: 14/989,104

(22) Filed: Jan. 6, 2016

(30) Foreign Application Priority Data
Apr. 1, 2015 (KR) 10-2015-0046044

(51) Int. Cl. H01F 27/28; H01F 27/29; H01F 27/24

(52) U.S. Cl. CPC H01F 27/2804; H01F 27/24; H01F 27/292; H01F 2027/2809

(57) ABSTRACT

A coil component includes a core member and coil conductors. The core member has an insulation layer in which a cavity having a stepped profile is provided in a central portion thereof, and a composite magnetic layer filling the cavity. The coil conductors are provided in the insulation layer. The stepped profile of the cavity increases a filling area or volume of the composite magnetic layer, such that common mode impedance may be improved by an increase in inductance under the same magnetic permeability condition.

### CROSS-REFERENCE TO RELATED APPLICATION

This application claims the priority and benefit of Korean Patent Application No. 10-2015-0046044 filed on Apr. 1, 2015, with the Korean Intellectual Property Office, the disclosure of which is incorporated herein by reference.

### BACKGROUND

The present disclosure relates to a coil component.

Recently, electronic devices such as mobile phones, personal computers (PCs), personal digital assistants (PDAs), liquid crystal displays (LCDs), navigation devices, and the like, have been miniaturized, thinned, and improved in terms of performance. Electronic devices such as those described above are highly sensitive to external stimuli, such that when a small abnormal voltage or high-frequency noise is introduced into an internal circuit of the electronic device from the outside, the circuit may become damaged or a signal may be distorted.

The abnormal voltage and/or the noise, as described above, may be caused by a switching voltage generated in a circuit, power noise included in a power source voltage, an unnecessary electromagnetic signal, electromagnetic noise, or the like. Coil components have been widely used as a means for preventing abnormal voltages and high-frequency noise from being introduced into the circuit.

A common mode filter (CMF), a type of coil component, is an electronic component widely used in various electronic devices in order to remove common mode noise.

Recently, in accordance with the trend toward miniaturization, thinness, and high performance in electronic devices, research has been conducted into a common mode filter capable of being miniaturized and thinned while exhibiting improved noise removing performance.

### SUMMARY

An aspect of the present disclosure may provide a coil component having a novel structure having improved characteristics.

According to an aspect of the present disclosure, a coil component may include a core member and coil conductors. The core member includes an insulation layer in which a cavity having a stepped profile is provided in a central portion thereof, and a composite magnetic layer filling the cavity. The coil conductors are provided in the insulation layer.

The insulation layer may be formed of a negative photoresist or a material cured by exposure to light.

A width of the cavity may be increased in a stepwise manner from a lower portion thereof toward an upper portion thereof.

The insulation layer may include a stack of a plurality of insulation sublayers, the cavity may be delimited by a plurality of side wall portions of the plurality of sublayers and step portions disposed between the side wall portions of sublayers adjacent to each other, and the side wall portions may be sloped at an angle of 90° or less.

The side wall portion of the cavity may include each of the side wall portions of the sub layers of the insulation layer.

Additionally, according to another aspect of the present disclosure, a coil component includes a core member and upper and lower cover members. The core member includes a stack of insulating sublayers each having coil conductors disposed therein. The upper and lower cover members are respectively disposed above and below the core member in a stacking direction of the insulating sublayers. Each insulating sublayer has a hole disposed in a center of the coil conductor. Additionally, areas of the holes disposed in respective insulating sublayers increase in the stacking direction of the insulating sublayers from the lower cover member to the upper cover member.

The hole of each respective insulating sublayer may be delimited by a wall portion, and the wall portion may be non-orthogonal to upper or lower surfaces of the respective insulating sublayer.

The coil component may further include a composite magnetic layer filling the holes disposed in each insulating sublayer of the stack of insulating sublayers. The composite magnetic layer and the upper and lower cover members may each include a magnetic powder mixed with a polymer resin.

In some examples, each respective insulating sublayer of the stack of insulating sublayers may include a plurality of coil conductors contacting a lower surface of the respective insulating sublayer, and insulation provided between the coil conductors of the respective insulating sublayer and between the coil conductors and an upper surface of the respective insulating sublayer.

In various examples, each respective insulating sublayer of the stack of insulating sublayers may include a plurality of coil conductors, and the coil conductors of different insulating sublayers of the coil component may be electrically connected to forma primary coil and a secondary coil. In one example, the coil conductors of each respective insulating sublayer are electrically connected to form a same one of the primary coil and the secondary coil. In another example, the first coil conductors of the insulating sublayers are electrically connected to form the primary coil, and the second coil conductors of the insulating sublayers are electrically connected to form the secondary coil.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a coil component according to an exemplary embodiment in the present disclosure;

FIG. 2 is an enlarged cross-sectional view taken along line I-I′ of FIG. 1;

FIG. 3 is a cross-sectional view of a coil component according to another exemplary embodiment in the present disclosure; and

FIGS. 4 through 13 are process views illustrating steps of a method of manufacturing the coil component of FIG. 1.

### DETAILED DESCRIPTION

Exemplary embodiments of the present disclosure will now be described in detail with reference to the accompanying drawings.

In the present exemplary embodiment, as an example of a coil component 100, a thin-film type common mode filter (CMF) is described.

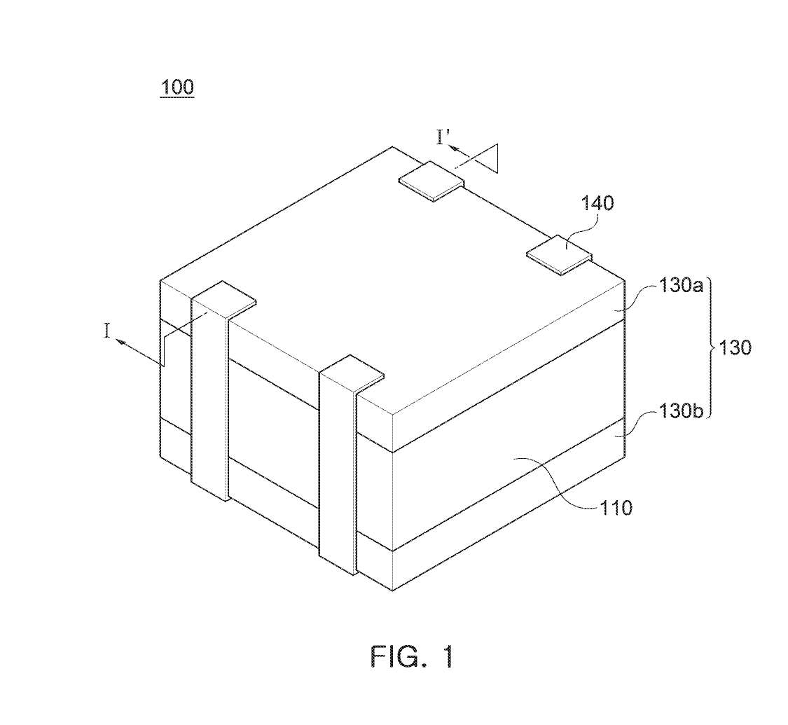

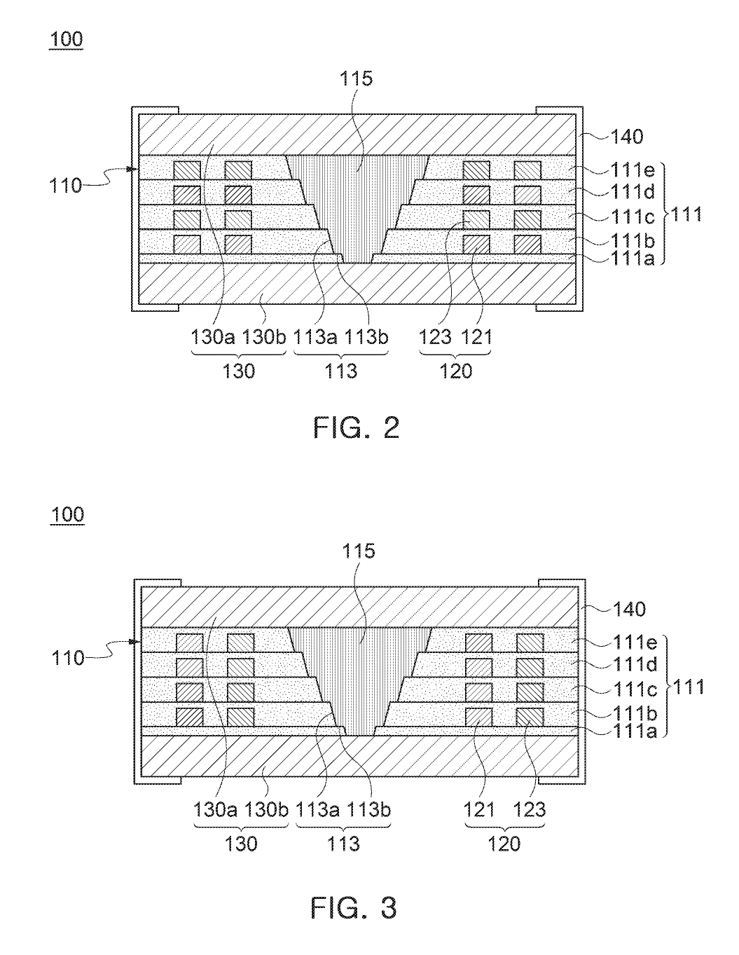

FIG. 1 is a perspective view of a coil component according to an exemplary embodiment in the present disclosure, FIG. 2 is an enlarged cross-sectional view taken along line I-I′ of FIG. 1, and FIG. 3 is a cross-sectional view of a coil component according to another exemplary embodiment in the present disclosure.

As illustrated in FIGS. 1 and 2, the coil component 100 according to the present exemplary embodiment may include a core member 110, coil conductors 120, a cover member 130, and external terminals 140.

The core member 110 may include an insulation layer 111 and a composite magnetic layer 115.

The insulation layer 111 may serve to secure insulation between the coil conductors 120 and protect the coil conductors 120 from an external environment. Specifically, the insulation layer 111 may support and enclose the coil conductors 120.

In detail, the insulation layer 111 may be formed of a plurality of sublayers including at least three sublayers. In FIG. 2, an insulation layer 111 composed of five sublayers (first to fifth insulation sublayers 111a to 111e) is illustrated.

However, the number of sublayers of the insulation layer 111 may be changed depending on the number of layers of the coil conductor 120. In this case, when the number of layers of the coil conductor 120 is n, the number of sublayers of the insulation layer 111 may be n+1 (here, n is an integer of 1 or more).

The insulation layer 111 as described above may include a cavity 113 in a central portion of a coil spiral in which the composite magnetic layer 115 is formed or disposed.

According to the present exemplary embodiment, the cavity 113 may be composed of or delimited by at least three side wall portions 113a and at least two step portions 113b. For example, the cavity 113 may be delimited by side wall portions 113a of the at least three sublayers of the insulation layer 111, and by step portions 113b formed along upper surfaces of the sublayers of the insulation layer 111 that are stepped back with respect to each other. In detail, the cavity 113 can have a stepped profile having a width that is gradually increased in a stepwise manner from a lower portion thereof toward an upper portion thereof. This is to increase an area of the cavity 113 and to increase a filling area or filling volume of the composite magnetic layer 115.

Here, the side wall portions 113a of the cavity 113 may be formed by side walls of each of the sublayers of the insulation layer 111, and the step portions 113b of the cavity 113 may be formed at interfaces of the insulation sublayers 111a-e between side wall portions 113a adjacent to each other.

Further, the side wall portions 113a of the cavity 113 may be sloped at an angle of 90° or less, preferably from about 60° to 90°. In this case, in view of improving a filling rate of the composite magnetic layer 115, it may be more preferable that the side wall portions 113a have a mild slope rather than a steep slope, because the area or volume of the cavity 113 maybe increased.

A range of the degree of slope of the side wall portion 113a as described above may be controlled depending on a type of material forming the insulation layer 111 or a process variation such as post bake after development, or the like, and currently, there is a process limitation in implementing the degree of slope less than 60°.

In addition, the insulation layer 111 may be formed of a material that is cured at the time of exposure to light, for example, a negative photoresist.

Here, the term “negative photoresist” refers to a photoresist of which a portion irradiated with light becomes insoluble in a developer due to a photoreaction.

The negative photoresist as described above may have a mild slope after development due to a solvent in the negative photoresist being volatilized at the time of curing through heat treatment after forming a film.

The composite magnetic layer 115 may fill the cavity 113 in the insulation layer 111.

At the time of applying a current to the coil component 100, a magnetic field in the central portion of the coil spiral maybe formed in a direction perpendicular or orthogonal to an upper surface of the insulation layer 111. Therefore, the composite magnetic layer 115 may serve as a path through which magnetic flux generated by current flow in the coil conductors 120 passes when applying a current to the coil conductors 120.

At the time of manufacturing the thin-film type common mode filter, when the central portion of the coil spiral is filled with a magnetic material having high magnetic permeability, inductance of the coil component 100 may be increased, such that common mode impedance of the common mode filter may be improved.

The composite magnetic layer 115 may be formed of a magnetic resin composite in which a magnetic powder is mixed with a polymer resin. Here, the magnetic powder may be formed of a

Ni-based ferritic material containing Fe₂O₃ and NiO as main ingredients, a Ni—Zn-based ferritic material containing Fe₂O₃, NiO, and ZnO as main ingredients, Ni—Zn—Cu-based ferritic material containing Fe₂O₃, NiO, ZnO, and CuO as main ingredients, or the like, which may allow high magnetic permeability to be secured.

The magnetic powder may be formed of any magnetic material in addition to the above-mentioned material. A magnetic material may be used in the magnetic powder as long as it allows a predetermined degree of inductance to be obtained. For example, Fe, a Fe—Ni-based alloy, a Fe—Si-based alloy, a Fe—Si—Al-based alloy, a Fe—Cr—Si-based alloy, or the like, may be used.

Meanwhile, in order to increase inductance of a common mode filter while keeping constant a magnetic permeability of a composite magnetic layer 115, a filling area or volume of the composite magnetic layer 115 including the magnetic material can be increased. The reason is that when a magnetic flux density has a unique value depending on a material, a magnetic flux passing through the corresponding magnetic material perpendicularly is in proportion to an area of the magnetic material.

Due to this principle, in the coil component 100 according to the present exemplary embodiment, inductance may be improved or increased while maintaining constant a magnetic permeability of a filling material filling the composite magnetic layer 115 in the cavity 113 having the stepped profile. Specifically, the inductance can be improved or increased by increasing the filling area or volume of the composite magnetic layer 115.

The composite magnetic layer 115 having the configuration as described above may be manufactured by preparing a magnetic paste containing the magnetic powder and the polymer resin in an organic solvent, filling the cavity 113 of the insulation layer 111 with the magnetic paste, and then curing the applied magnetic paste film.

The coil conductor 120, a metal wiring of a coil pattern wound in a spiral shape, maybe formed of at least one metal selected from silver (Ag), palladium (Pd), aluminum (Al), nickel (Ni), titanium (Ti), gold (Au), copper (Cu), and platinum (Pt), which have excellent electrical conductivity.

The coil conductor 120 may be formed in a structure in which the coil conductors 120 are embedded in the insulation layer 111, and may be provided in each of the insulation sublayers 111b to 111e except for an insulation sublayer 111a disposed in a lowermost position.

The coil conductor 120 as described above may be composed of a primary coil 121 and a secondary coil 123. As illustrated in FIG. 2, the primary coil 121 and the secondary coil 123 may be alternately disposed in each of the sublayers. In FIG. 2, the primary coil is shown with hashing in one direction (′/′), while the secondary coil (123) is shown with hashing in the other direction (′′). In this case, lower surfaces of the primary coil 121 and the secondary coil 123 may be disposed on the same plane as lower surfaces of respective insulation sublayers 111b to 111e in which the primary coil 121 or the secondary coil 123 is provided. Further, as shown, the primary coil 121 is formed in a first set of sublayers of the insulation layer 111 (specifically, in sublayers 111b and 111d, in the example of FIG. 2), while the secondary coil is formed in a second set of sublayers interposed between layers of the first set (specifically, in sublayers 111c and 111e).

Primary coils 121 disposed on different planes may be electrically connected to each other through a first via (not illustrated), and secondary coils 123 disposed on different planes may be electrically connected to each other through a second via (not illustrated). For example, the primary coils 121 disposed on different planes may be electrically connected to each other in series through the first via, and secondary coils 123 disposed on different planes may be electrically connected to each other in series through the second via.

In addition, end portions of the primary coil 121 and the secondary coil 123 may be extended to side surfaces of the core member 110, such that distal ends thereof may be exposed externally, and exposed portions of the distal ends may be electrically connected to four external terminals 140 formed on side surfaces of a body formed by stacking the core member 110 and the cover member 130. An external current may be applied to the coil conductor 120 through the external terminals 140 due to this connection structure.

Here, among the four external terminals 140, one pair of external terminals 140 serving as input and output terminals of the primary coil 121 may be provided on one side surface and the other side surface of the body, respectively, to thereby be disposed to face each other, and the other pair of external terminals 140 serving as input and output terminals of the secondary coil 123 may also be disposed in the structure as described above. However, a dispositional structure of the external terminals 140 is not necessarily limited thereto, but may be freely changed depending on a design.

The primary coil 121 and the secondary coil 123 are disposed to be adjacent to each other and may thus be electromagnetically coupled to each other. As a result, the coil component 100 according to the present exemplary embodiment may operate as a common mode filter (CMF) having a common mode impedance that is increased due to reinforcement of magnetic flux when a current is applied to the primary coil 121 and the secondary coil 123 in the same direction, and having a differential mode impedance that is decreased due to attenuation of magnetic flux when currents flow in different directions.

Meanwhile, although an example in which the primary coil 121 and the secondary coil 123 are disposed on different planes is illustrated in FIG. 2, the coil conductor 120 can alternatively be formed in a general simultaneous coil structure in which the primary coil 121 and the secondary coil 123 are disposed adjacently on a single sublayer, that is, on the same plane as each other as illustrated in FIG. 3.

Each of the primary coil 121 and the secondary coil 123 may be formed of a plating pattern by a plating method, which is advantageous in situations in which thinning of the coil component is desired. A detailed description thereof will be provided in the following description of a method of manufacturing a coil component.

Further, the insulation layer 111 composed of the plurality of sublayers (111a-) and the coil conductors 120 of the plurality of sublayers may be formed by repeatedly forming the insulation sublayers and the coil conductor several times.

The cover member 130 maybe formed on both surfaces (e.g., upper and lower surfaces) of the insulation layer 111 in which the coil conductors 120 are embedded, and disposed on outermost portions of the coil component 100 to thereby constitute the body together with the core member 110 and the coil conductor 120.

The cover member 130 may be composed of an upper cover member 130a disposed on the core member 110 and a lower cover member 130b disposed below the core member 110.

The cover member 130 may be formed of a magnetic resin composite in which magnetic powder is mixed with a polymer resin, similarly to the composite magnetic layer 115. In this case, the cover member 130 may serve as a movement path of the magnetic flux together with the composite magnetic layer 115.

That is, the magnetic flux generated when a current is applied to the coil conductor(s) 120 may pass through the cover member 130 in upper and lower portions of the coil component 100 and pass through the composite magnetic layer 115 in a central portion of the coil component 100, thereby forming a closed magnetic circuit. Therefore, magnetic flux leakage may be suppressed by the cover member 130, such that deterioration of electrical characteristics of the coil conductor 120 may be prevented.

Meanwhile, in a case in which the cover member 130 is formed of a magnetic resin composite having the same content ratio of the magnetic powder as that of the composite magnetic layer 115, directionality of device characteristics may be improved.

The coil component 100 according to the present exemplary embodiment having the configuration as described above may include the cavity 113 having the stepped profile in the insulation layer 111 corresponding to the central portion of the coil spiral to increase the filling area or volume of the composite magnetic layer 115, such that common mode impedance may be improved by an increase in inductance under the same magnetic permeability conditions.

A method of manufacturing the coil component according to the present exemplary embodiment, configured as described above, will be described below. Here, the same components as those in FIGS. 1 and 2 are denoted by the same reference numerals, overlapping descriptions of the same components will be omitted, and only differences therebetween will be described.

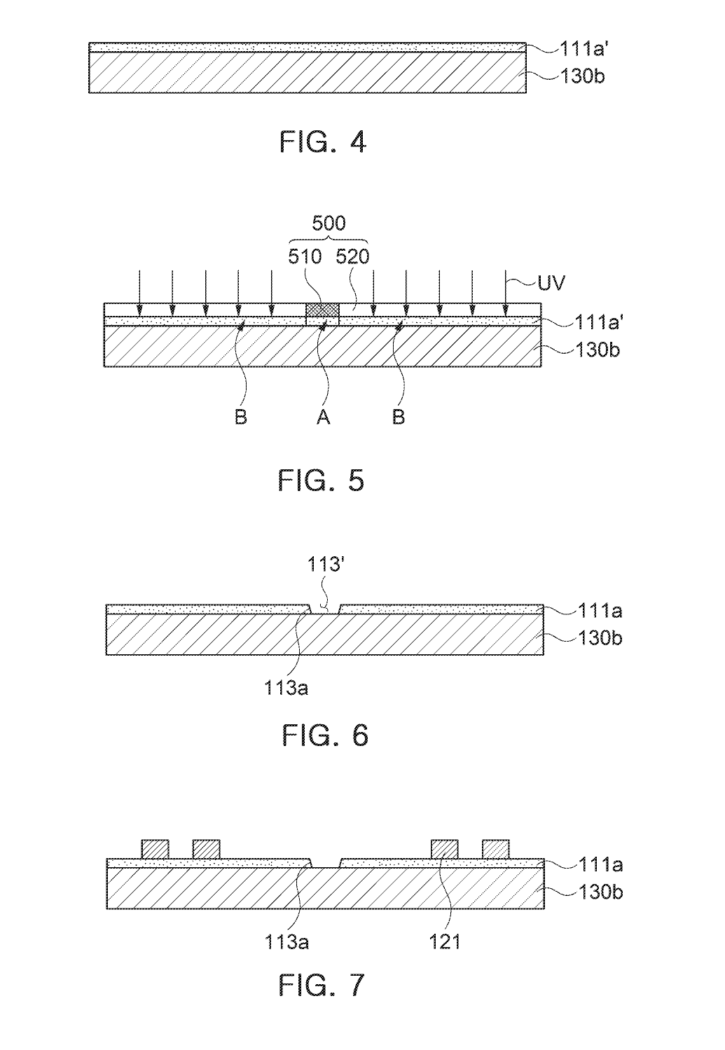

FIGS. 4 through 13 are process views illustrating respective steps of a method of manufacturing the coil component of FIG. 1.

As illustrated in FIG. 4, in the method of manufacturing a coil component according to the present exemplary embodiment, first, a first insulation layer 111a′ may be formed by applying a negative photoresist, which is a material that is cured at the time of exposure to light, on a prepared lower cover member 130b.

Next, as illustrated in FIG. 5, after arranging a mask 500 including a blocking portion 510 and a transmission portion 520 on the first insulation layer 111a′, exposure to light may be performed by irradiating ultraviolet (UV) light, or the like.

Here, the blocking portion 510 of the mask 500 may block transmission of light to the portions of the first insulation layer 111a′ overlaid by the blocking portion 510. Meanwhile, the transmission portion 520 of the mask may transmit light to those portions of the first insulation layer 111a′ overlaid by the transmission portion 520. Therefore, the blocking portion 510 may correspond to a region of the first insulation layer 111a′ on which the cavity will be formed. The transmission portion 520 may cover regions that are not covered by the blocking portion 510, and may thereby correspond to the other region in which the insulation layer 111a′ will remain.

Therefore, portions of the first insulation layer 111a′ corresponding to the blocking portion 510 of the mask 500 may be referred to as a non-exposed portion A, and portions of the first insulation layer 111a′ corresponding to the transmission portion 520 of the mask 500 may be referred to as an exposed portion B.

In this case, the exposed portion B may be photocured, and the non-exposed portion A may not be photocured to thereby be in an uncured state. The mask 500 may be removed after exposure to light.

Next, as illustrated in FIG. 6, the exposed first insulation layer (see 111a′, portion B, of FIG. 5) maybe developed.

At the time of development, since the exposed portion B of FIG. 5 is insoluble in a developer, the exposed portion B may remain, and the non-exposed portion A may be removed by the developer, such that a first insulation layer 111a including a first cavity 113′ may be formed in a region corresponding to the non-exposed portion A.

In this case, a side wall portion 113a of the first cavity 113′ may be sloped at an angle of about 60° to 90°, preferably, a mild slope, with respect to a surface of the lower cover member 130b. The reason is that the negative photoresist forming the first insulation layer 111a′ of FIG. 5 has a mild slope due to a solvent in the negative photoresist being volatilized at the time of curing through heat treatment after forming a film.

Thereafter, as illustrated in FIG. 7, a primary coil 121 may be formed on the first insulation layer 111a including the first cavity 113′.

The primary coil 121 may be formed of a spiral plating pattern using a general plating method.

In this case, a distal end of the primary coil 121 may be exposed externally by extending one end portion of the primary coil 121 to one side surface of the first insulation layer 111a on which external terminals will be formed.

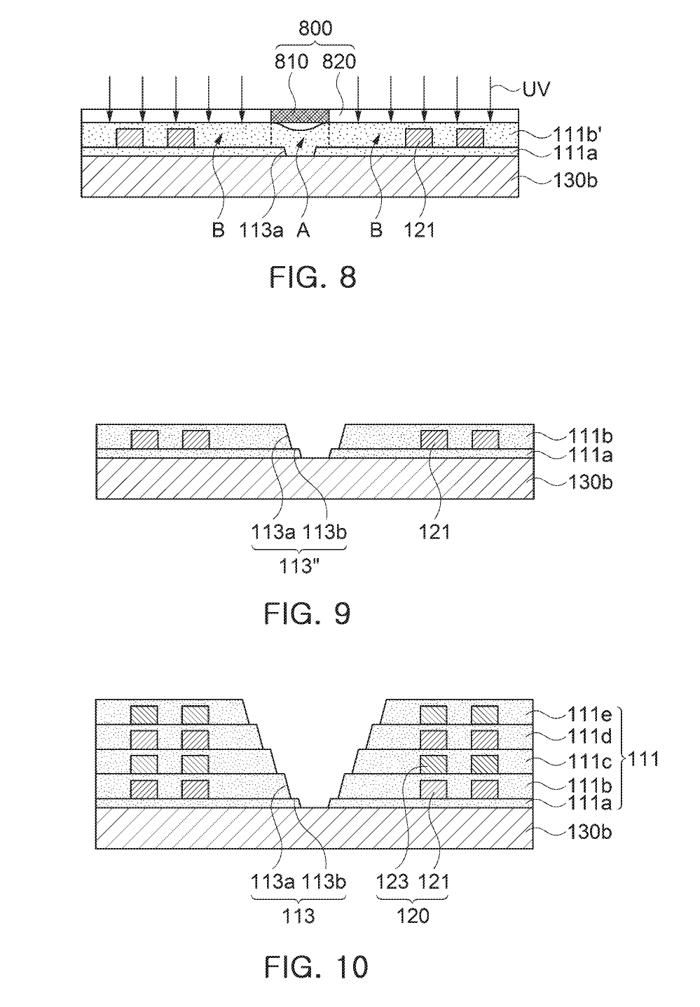

Next, as illustrated in FIG. 8, a second insulation layer 111b′ may be formed on the first insulation layer 111a to cover the primary coil 121, a mask 800 including a blocking portion 810 and a transmission portion 820 may be arranged on the second insulation layer 111b′, and then, exposure to light may be performed by irradiating UV light, or the like. The second insulation layer 111b′ may be formed on the first insulation layer 111a to have a depth larger than a height of the primary coil 121, such that the second insulation layer 111b′ fully covers the primary coil 121.

A configuration of the mask 800 is the same as that of the above-mentioned mask 500, except that an area of the blocking portion 810 is wider than that of the blocking portion 510 of FIG. 5. Further, the blocking portion 810 is substantially vertically aligned with the position of the blocking portion 510 and of the first cavity 113′.

Therefore, the second insulation layer 111b′ corresponding to the blocking portion 810 of the mask 800 may be changed into a non-exposed portion A by exposure to light, and the second insulation layer 111b′ corresponding to the transmission portion 820 of the mask 800 may be changed into an exposed portion B.

In this case, the exposed portion B may be photocured, and the non-exposed portion A may not be photocured to thereby be in an uncured state. The mask 800 may be removed after exposure to light.

Next, as illustrated in FIG. 9, the exposed second insulation layer (see 111b′ of FIG. 8) may be developed.

At the time of development, since the exposed portion B of FIG. 8 is insoluble in a developer, the exposed portion B may remain, and the non-exposed portion A may be removed by the developer, such that a second insulation layer 111b including a second cavity 113″ having an area wider than that of the first cavity 113′ may be formed in a region corresponding to the non-exposed portion A.

In this case, a side wall portion 113a of the second cavity 113″ may be sloped at an angle of about 60° to 90° with respect to an upper surface of the first insulation layer 111a, and the principle applied to the second cavity 113″ may be the same as the principle applied to the above-mentioned first cavity 113′.

Next, as illustrated in FIG. 10, an insulation layer 111 including a cavity 113 having a stepped profile composed of a plurality of side wall portions 113a and a plurality of step portions 113b, and a coil conductor 120 composed of primary and secondary coils 121 and 123 embedded in the insulation layer 111 may be formed by repeatedly forming the insulation layer and the coil several times as described above in relation to FIGS. 7-9 above. As a result, the cavity 113 may have the stepped profile of which a width is gradually increased in a stepwise manner from a lower portion thereof toward an upper portion thereof.

In this process, one end portion of the primary coil 121 and of the secondary coil 123 may be extended to one side surface or the other side surface of each of the insulation layers 111 corresponding to side surfaces of a body on which four external terminals will be formed, such that distal ends of the primary coil 121 and the secondary coil 123 may be exposed externally.

Meanwhile, although not illustrated, at the time of forming the cavity in each of the layers of the insulation layer 111, if necessary, a first via hole for a first via for electrically connecting the primary coils 121 formed on different planes to each other or a second via hole for a second via for electrically connecting secondary coils 123 formed on different planes to each other may be simultaneously formed.

In a mask for a cavity and a via used to simultaneously form the cavity and the via, a blocking portion for a via corresponding to a region in which the via will be formed may be additionally included, such that the cavity and the via may be simultaneously formed by exposure to light and development. Simultaneous formation of the cavity and the via hole as described above may relatively decrease the number of masks or processes required.

Further, the first and second vias may be formed by filling a conductive material in each of the first and second via holes using a plating method.

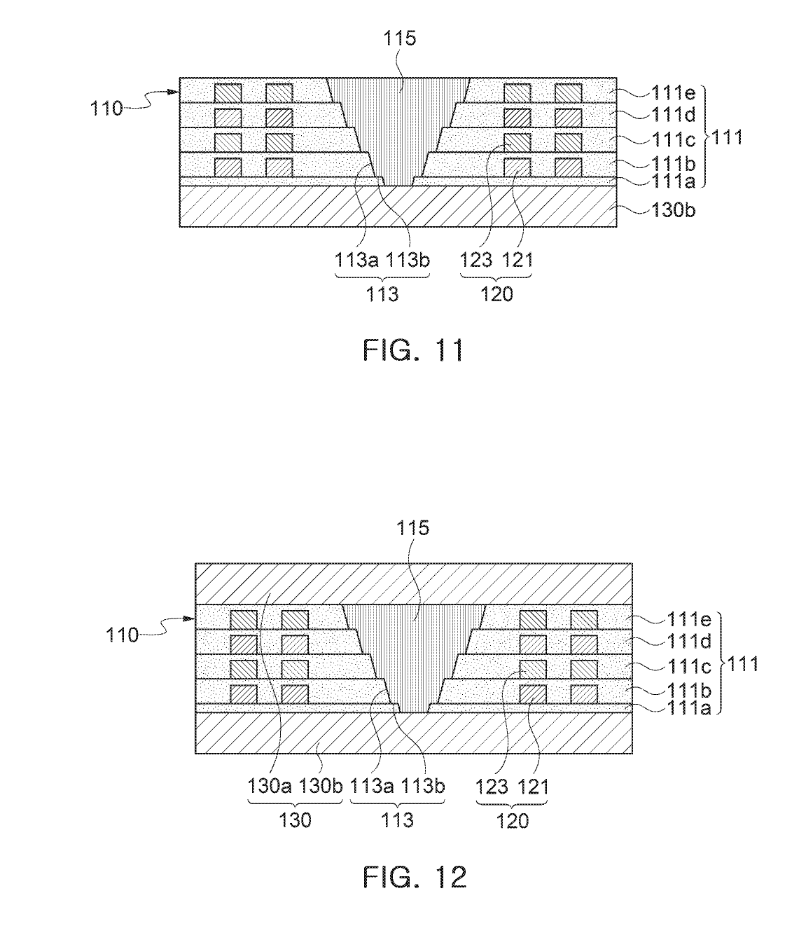

Next, as illustrated in FIG. 11, a composite magnetic layer 115 may be formed to fill the cavity 113 of the insulation layer 111, thereby completing a core member 110.

The composite magnetic layer 115 may be formed by preparing a magnetic paste containing magnetic powder and a polymer resin in an organic solvent, filling the cavity 113 of the insulation layer 111 with the magnetic paste, and then curing the applied magnetic paste.

Thereafter, as illustrated in FIG. 12, an upper cover member 130a may be stacked on the composite magnetic layer 115 and the insulation layer 111. Therefore, a body composed of the core member 110, the coil conductors 120, and the cover member 130 may be completed.

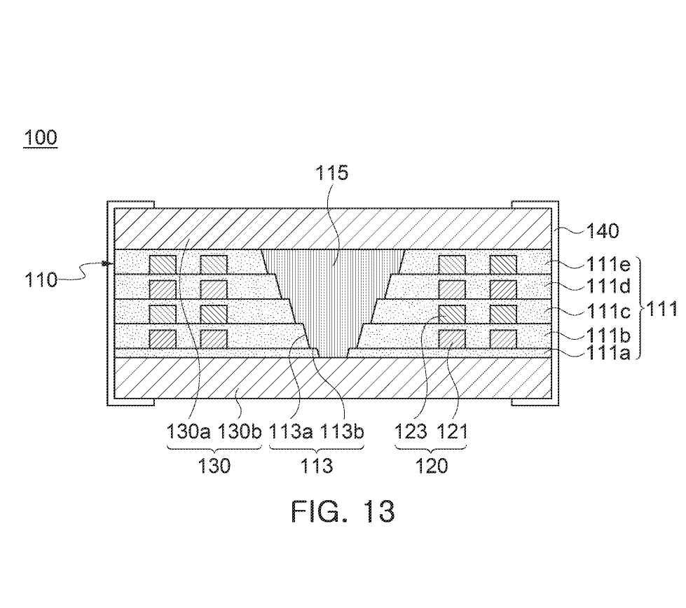

Then, as illustrated in FIG. 13, four external terminals 140 may be formed on positions of the body corresponding to one end portions of the coil conductors 120 exposed to the side surfaces of the body, thereby completing the coil component 100.

The coil component 100 according to the present exemplary embodiment manufactured by the configuration and method as described above may be thinned, and at the same time, the coil component 100 may have improved common mode impedance by an increase in inductance under the same magnetic permeability conditions.

Further, since the via hole may be simultaneously formed at the time of forming the cavity in each of the insulation layers, manufacturing costs may be decreased and a process yield may be improved by relatively decreasing the number of masks or processes required.

As set forth above, the coil component according to exemplary embodiments in the present disclosure may include the cavity having the stepped profile in the insulation layer corresponding to the central portion of the coil spiral. The stepped profile may result in an increase in the filling area or volume of the composite magnetic layer filling the cavity, such that common mode impedance may be improved by the increase in inductance under the same magnetic permeability condition.

While exemplary embodiments have been shown and described above, it will be apparent to those skilled in the art that modifications and variations could be made without departing from the scope of the present invention as defined by the appended claims.

What is claimed is:

1. A coil component comprising:
a core member including an insulation layer in which a cavity having a stepped profile is provided in a central portion thereof, and a composite magnetic layer filling the cavity; and
coil conductors provided in the insulation layer.

2. The coil component of claim 1, wherein the insulation layer is formed of a negative photoresist.

3. The coil component of claim 1, wherein the insulation layer is formed of a material cured by exposure to light.

4. The coil component of claim 1, wherein a width of the cavity is increased in a stepwise manner from a lower portion thereof toward an upper portion thereof.

5. The coil component of claim 1, wherein the insulation layer includes a stack of a plurality of insulation sublayers, the cavity is delimited by a plurality of side wall portions of the plurality of sublayers and step portions disposed between the side wall portions of sublayers adjacent to each other, and
the side wall portion of each sublayer slopes at an angle of 90° or less with respect to a lower surface of the sublayer.

6. The coil component of claim 1, wherein the coil conductors include a primary coil and a secondary coil electromagnetically coupled to each other.

7. The coil component of claim 6, wherein the primary coil and the secondary coil are disposed on different planes.

8. The coil component of claim 6, wherein the insulation layer includes a stack of a plurality of insulation sublayers, and the primary coil and the secondary coil are disposed in different respective sublayers of the plurality of sublayers.

9. The coil component of claim 6, wherein the primary coil and the secondary coil are disposed on the same plane.

10. The coil component of claim 6, wherein the insulation layer includes a stack of a plurality of insulation sublayers, and the primary coil and the secondary coil are disposed in a same sublayer of the plurality of sublayers.

11. The coil component of claim 1, wherein the coil conductor is formed of a plating pattern.

12. The coil component of claim 1, wherein:
the coil conductors include a plurality of primary coils and a plurality of secondary coils electromagnetically coupled to each other, and
the coil component further comprises a first via connecting the primary coils to each other and a second via connecting the secondary coils to each other in the insulation layer.

13. The coil component of claim 1, further comprising a cover member formed on opposing surfaces of the core member.

14. The coil component of claim 1, further comprising four external terminals formed on side surfaces of the core member and electrically connected to respective ends of the coil conductors.

15. A coil component comprising:
a core member comprising a stack of insulating sublayers each having coil conductors disposed therein; and
upper and lower cover members respectively disposed above and below the core member in a stacking direction of the insulating sublayers,
wherein each insulating sublayer has a hole disposed in a center of the coil conductor, and
wherein areas of the holes disposed in respective insulating sublayers increase in the stacking direction of the insulating sublayers from the lower cover member to the upper cover member.

16. The coil component of claim 15, wherein the hole of each respective insulating sublayer is delimited by a wall portion, and the wall portion is non-orthogonal to upper or lower surfaces of the respective insulating sublayer.

17. The coil component of claim 15, further comprising:
a composite magnetic layer filling the holes disposed in each insulating sublayer of the stack of insulating sublayers,
wherein the composite magnetic layer and the upper and lower cover members each include a magnetic powder mixed with a polymer resin.

18. The coil component of claim 15, wherein each respective insulating sublayer of the stack of insulating sublayers comprises a plurality of coil conductors contacting a lower surface of the respective insulating sublayer, and insulation provided between the coil conductors of the respective insulating sublayer and between the coil conductors and an upper surface of the respective insulating sublayer.

19. The coil component of claim 15, wherein:
each respective insulating sublayer of the stack of insulating sublayers comprises a plurality of coil conductors,
the coil conductors of different insulating sublayers of the coil component are electrically connected to form a primary coil and a secondary coil, and
the coil conductors of each respective insulating sublayer are electrically connected to form a same one of the primary coil and the secondary coil.

20. The coil component of claim 15, wherein:
each respective insulating sublayer of the stack of insulating sublayers comprises first and second coil conductors,
the coil conductors of different insulating sublayers of the coil component are electrically connected to form a primary coil and a secondary coil, and
the first coil conductors of the insulating sublayers are electrically connected to form the primary coil, and the second coil conductors of the insulating sublayers are electrically connected to form the secondary coil.
